(19) United States
(12) Patent Application Publication
(10) Pub. No.: US 2025/0256931 A1
(43) Pub. Date: Aug. 14, 2025

(54) EQUIPMENT FOR LOADING AND UNLOADING TRUCKS AND METHOD FOR LIFTING LOADS

(71) Applicant: Carlos Adell Péricas, Rio Negrinho (BR)

(72) Inventor: Carlos Adell Péricas, Rio Negrinho (BR)

(21) Appl. No.: 18/854,923

(22) PCT Filed: Aug. 23, 2023
(86) PCT No.: PCT/BR2023/050275

§ 371 Date: Oct. 7, 2024

(30) Foreign Application Priority Data
Oct. 17, 2022 (BR) 1020220210152
May 9, 2023 (BR) 1020230088660

(51) Int. Cl. B65G 67/02; B66F 9/02

(52) U.S. Cl. CPC B65G 67/02; B66F 9/02

(57) ABSTRACT

An apparatus for loading and unloading any truck without the need for any adaptation or automation of the trailer, by means of movable pliable pneumatic lifting beams, i.e., beams that correct the direction of movement based on the alignment of the trailer, or that accommodate any different angle of the trailer in relation to the loading bay, such as, for example, the movement of the suspension of the truck itself as the cargo is loaded, or the angle between the trailer door and the front part of said trailer as the trailer is lifted at the door to align the bay to the entry of the pneumatic lifting beams.

### TECHNICAL FIELD

The present invention belongs to the technological field of logistics, more specifically, it refers to a new way of loading palletized products into a truck or similar, through the movement of lifting beams installed on equipment at the dock into the truck, carrying the full load and exiting empty from the truck or, similarly, entering with the empty lifting beams into the truck and exiting with the full load, all carried out quickly and fully automatically.

### STATE OF THE ART

In the field of freight transportation, the logistics of loading and unloading trucks demands large structures and high labor costs at companies' logistics centers. All cargo must be transported from pallet racks to the docks and then into trucks and trailers by manual or electric pallet jacks. For example, loading a trailer, which typically carries thirty PBR pallets, requires around thirty trips with a forklift or pallet jack in and out of the trailer, resulting in loading or unloading times of around forty-five minutes to an hour in most operations.

Consequently, large logistics centers often have long lines of trucks waiting to be loaded or unloaded, significantly increasing freight costs. Every idle truck incurs a high cost, and drivers, often paid monthly, end up waiting for hours, resulting in losses for transport companies and higher costs for contracting companies. Reducing the waiting time for trucks during loading or unloading is a way to reduce transportation costs and increase companies' competitiveness, lowering the final cost of products on store shelves.

The same author has made other utility model requests for systems involving loading and unloading by moving floors, including BR 2020120262512
Truck Loading and Unloading System by Moving Floor, BR 2020130097409-Moving Floor Loading and Unloading System for Containers, BR 2020130098642
Dock Loading System with Moving Floor, and BR 2020140198240-Moving Floor Loading and Unloading System with Multiple Conveyors. Hundreds of these systems are in operation in large companies, moving over half a million tons monthly. With this experience, the author has now invented an innovative system for fully automated truck loading of palletized products without requiring any adaptation or automation on the trailer, unlike previous patents.

Some manufacturers in Europe offer systems for the same purpose, but all these systems necessarily require that the pallets have a “free entry” facing the trailer door or that recessed rails are installed inside the trailer, such as Joloda Riserplate Skates—England with application number EP2845823, to grab the pallets from underneath. However, with the standardization of the PBR pallet in Brazil to better utilize the trailer volume, pallets are placed with the closed side facing the trailer door, meaning the 1.2 m side faces the door, forming 2.4 m wide blocks, making it impossible to grab the load with equipment without inserting it into the pallet.

In the author's automated loading and unloading systems, with automated trailers, they are equipped with stops that allow the correct alignment of the trailer with the automated dock, making the loading or unloading process take only two minutes. However, in this case, it is necessary to automate and prepare the trailers—with equipment that remains fixed inside the trailer or truck—and therefore, these operations are often dedicated. The big challenge has always been to find a solution to load or unload trucks without having to automate or make any changes to the truck or trailer, meaning that any truck can be loaded or unloaded by this new solution presented, unique to these pallet formats (PBR or Europallet) sideways.

To achieve this, since each truck has different internal dimensions and different floor heights, the equipment uses mechanisms that align the truck to the dock, moving the rear laterally, lifting the rear, and, if necessary, also moving the front (fifth wheel) of the trailers.

### Innovations and Objectives of the Invention

The present invention aims to provide equipment for loading and unloading trucks that effectively resolves the limitations of the state of the art mentioned above.

The proposed system has flexible pneumatic lifting beams, meaning they correct the direction of movement based on the alignment of the trailer or follow any angle difference between the trailer and the dock, such as the movement of the truck's suspension as the load enters, or the angle formed between the trailer door and its front part, as the trailer is lifted at the door to align the dock with the entrance of the pneumatic lifting beams.

The system's movement is driven by mechanisms powered by either electrical energy with an electric motor or a hydraulic unit. The entire process of loading or unloading a truck, or similar, can be completed in less than five minutes, depending on the characteristics of the truck or similar, or even the material being loaded.

The height loss of the products on the pallets is 30 mm, meaning the equipment lifts and moves the pallets raised by just 30 mm, allowing loads with heights equal to or greater than those loaded manually.

### Advantages and Technical Effects of the Invention

The equipment for loading and unloading trucks, the object of the present invention, offers the following advantages and achieves the following technical effects compared to the state of the art:

The state-of-the-art equipment for loading and unloading trucks requires adjustment or adaptation of the trailer to the loading/unloading location to enable the movement of the load inside the trailer. This is resolved by the present invention through flexible pneumatic lifting beams that adjust according to the trailer being loaded or unloaded, allowing the equipment to adapt to the trailer instead of requiring the trailer to adjust to the equipment.

The state-of-the-art systems for loading and unloading trucks require the pallets to have a “free entry” facing the trailer door or to install recessed rails inside the trailer to grab the pallets from underneath, limiting the equipment's versatility as it cannot handle various types of pallets. This is resolved by the present invention through pneumatic lifting beams that can be inserted into the pallets, lifting and moving them with their movable wheels, allowing the transport of any type of pallet.

The state-of-the-art systems for loading and unloading trucks require the application of high force/pressure by the equipment to lift and move the load/pallets being loaded onto the truck trailer. This issue is resolved by the present invention through a pneumatic hose, which receives air inside, generating pressure with a large contact area. As Force=Area*Pressure, the equipment does not require high pressure, as it has a large contact area, producing a high force for lifting the pallets without needing high pressure.

### LIST OF ATTACHED DRAWINGS

To enable the present invention to be fully understood and implemented by any technician in this technological field, it is described clearly, precisely, and sufficiently based on the attached drawings listed below, which illustrate preferred embodiments of the equipment for loading and unloading trucks:

FIG. 1—Perspective view of the truck loading and unloading equipment along with the pallet conveyor; FIG. 2—Enlarged perspective view of the upper part of the truck loading and unloading equipment along with the pallet conveyor; FIG. 3—Enlarged perspective view of the lower part of the truck loading and unloading equipment; FIG. 4—Perspective view of the lifting beam; FIG. 5—Bottom perspective view of the lifting beam; FIG. 6—Exploded perspective view of the lifting beam; FIG. 7—Perspective view of the lifting beam with the wheels retracted; FIG. 8—Perspective view of the lifting beam with the wheels expanded; FIG. 9—Bottom perspective view of the lifting beams with retracted wheels inserted into the pallet openings; FIG. 10—Bottom perspective view of the lifting beams with expanded wheels inserted into the pallet openings; FIG. 11—Illustration of the truck loading and unloading equipment installed in a warehouse along with a trailer; FIG. 12—Illustration of the trailer being loaded through the truck loading and unloading equipment.

### DETAILED DESCRIPTION OF THE INVENTION

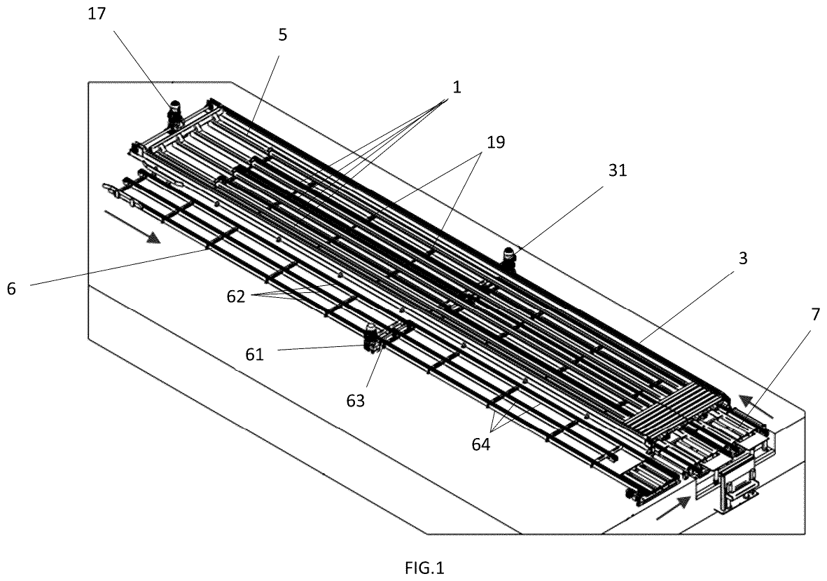

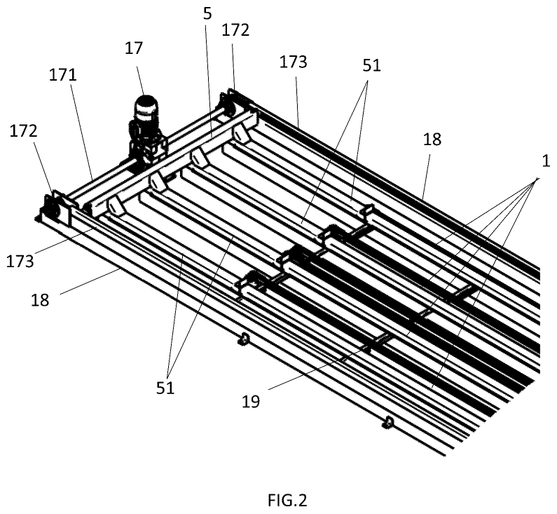

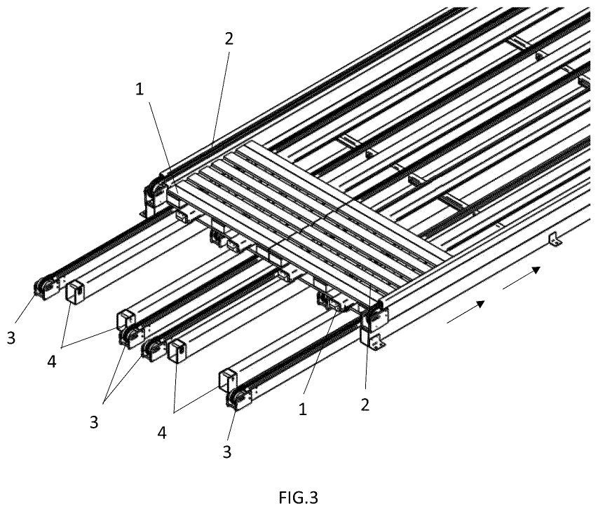

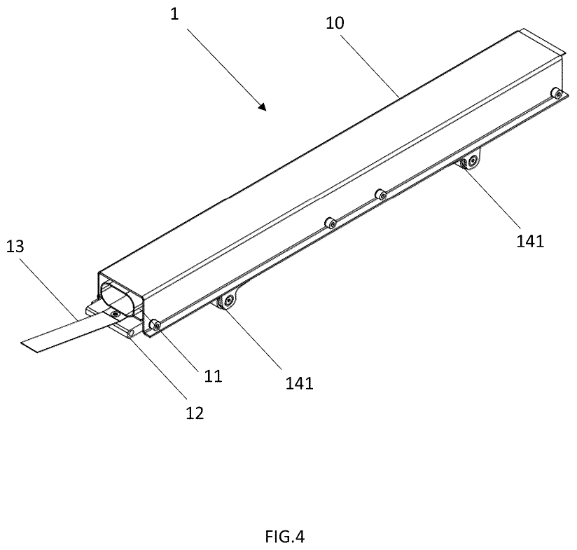

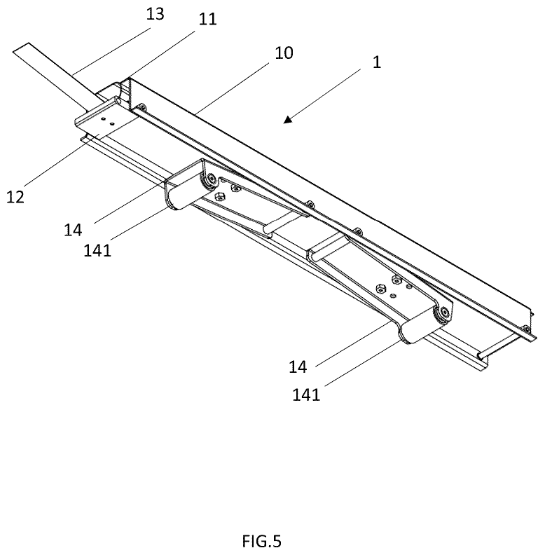

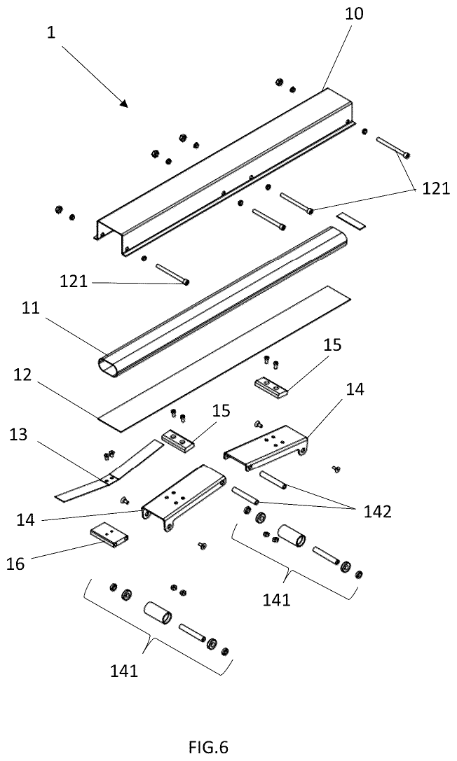

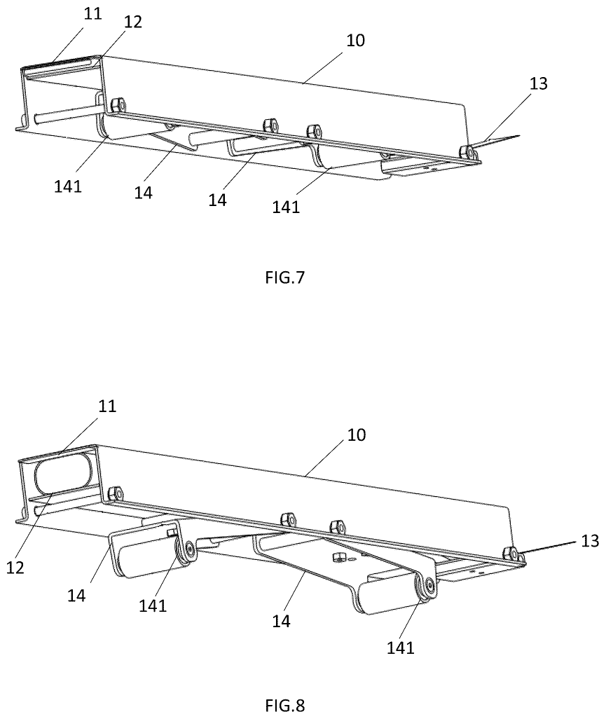

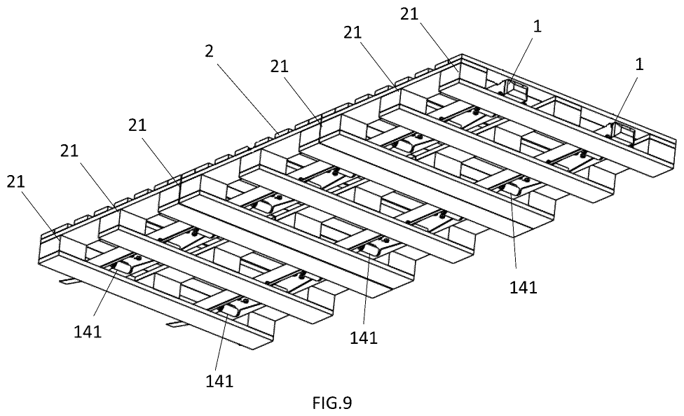

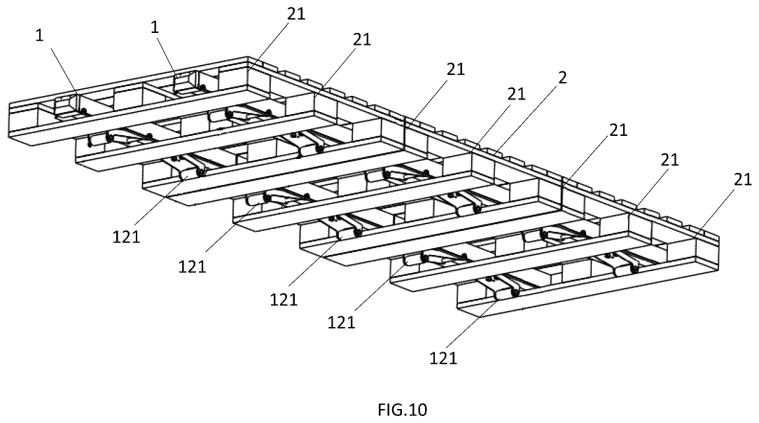

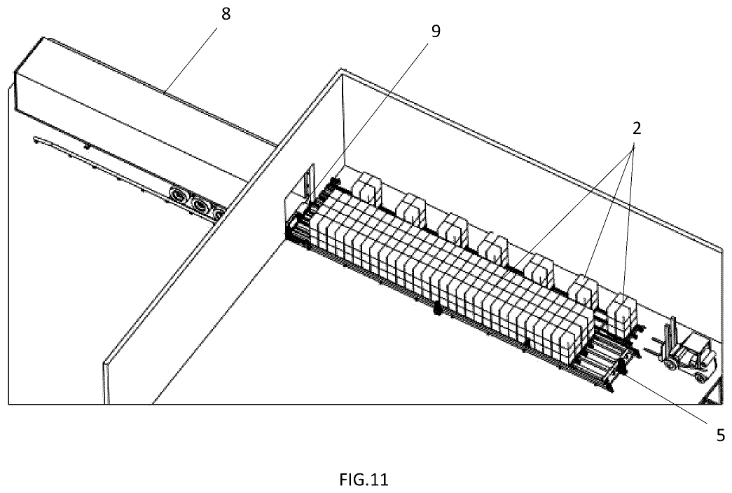

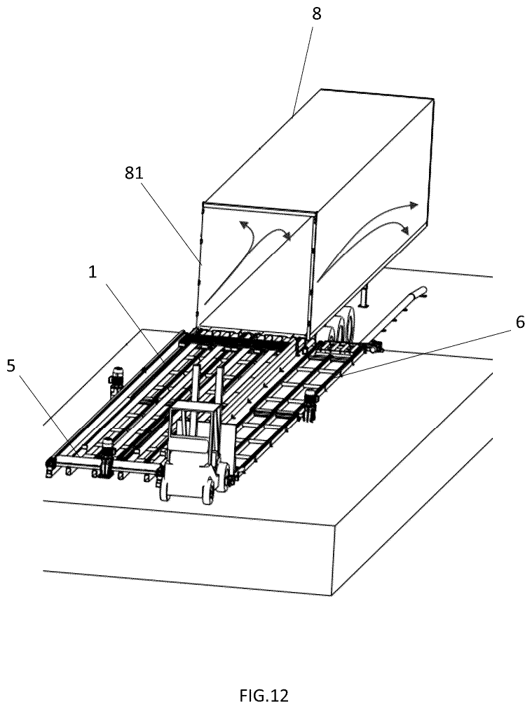

FIGS. 1 and 2 show the truck loading and unloading equipment composed of four or more lifting beams (1) moved by a carriage (5) with arms (51) operated by a motor (17). The carriage's (5) arms (51) are fixed to the pneumatic lifting beams (1) and, through the activation of the motor (17) that rotates the shaft (171) connected to the gears (172), move the chains (173) where the carriage (5) is fixed. The equipment also includes ducts (18) that enclose the chains (173) and fix the shaft (171) to the gears (172) at their ends, and horizontal beams (19) that secure the rails (4) and ducts (18) to each other. Alternatively, the equipment contains a second line of chain conveyors (6) that can be used to load the entire system from behind, and its motorization (61) moves the pallets (2) (in the direction of the arrows shown). The motor (61), connected to the chains (62) through a shaft (63), moves the chains (62) inside the ducts (64), acting as “rails” for moving the pallets (2) and guiding them to the roller mechanism (7). Similarly, in the case of unloading, the movements are reversed.

FIG. 3 shows the pallet loading and unloading equipment for trucks, allowing the passage of the four pneumatic lifting beams (1) through the pallets (2) by moving the pallets (2) over the chain conveyors (3) driven by the motor (31), which move the pallets (2) towards the lifting beams (1), positioning all the pallets in the system as indicated by the arrows in the figure. Once the desired number of pallets (2) for a complete load is ready, the system will move when the wheels (141) of the pneumatic lifting beams (1) are activated, moving them over the rails (4) formed by bars where the wheels (141) of the beams (1) fit and move, driven by the carriage (5).

The motor (31) is responsible for moving the chain conveyors (3) that move the pallets (2) to form the load, ensuring through sensors that they are all correctly aligned as the beam system (1) “enters” the pallet structures (2) as shown in FIGS. 8 and 9. For this reason, all pallets must come from the transfer area, formed by the roller mechanisms (7) in the direction of the rear carriage (5).

The equipment contains an electromechanical control and energization system. It is connected directly to an electrical network or any means that provides sufficient electrical energy to operate the equipment and is directly connected to a PLC—programmable logic controller—that provides the commands to start/stop, load/unload the equipment.

FIGS. 4 to 6 illustrate the lifting beam (1) that forms part of the truck loading and unloading equipment, consisting of a rigid plate (10) placed over a pneumatic hose (11) pressed against its lower part with a plate (12) connected to a leaf spring (13). Connected to the plate (12) through fastening elements, the beam (1) contains two movable arms (14) that move up and down, with wheels (141) that allow the beam to move.

The arms (14) pivot around shafts (142) fixed to the plate (10) and have wheels (141) attached to the end of the arm (14). Preferably, the wheels (141) are cylindrical rollers with bearings and are fixed through a shaft and fastening elements; however, their arrangement is not limited to this, as the wheels (141) can alternatively be any type of wheel or element that allows the rotation and movement of the beam.

The platform (12) is supported on shafts (121) that pass through the sides of the plate (1), fixed by screws and nuts.

FIG. 7 illustrates the lifting beam (1) with the wheels (141) retracted and the pneumatic hose (11) compressed against a platform (12) by springs (13). When air is introduced into the system, the hose (11) moves the platform (12) and the springs (13) downward, pushing the wheels (141) out of the structure plate (10), as illustrated in FIG. 8, thus lifting the products placed on it through the pressure applied to the wheel arm (14) by the support (15), made of sliding material, appropriately placed according to the lifting stroke required by the system.

The pneumatic hoses (11) are connected to a compressor, valves, and regulators that supply air to the system.

The springs (13) of the lifting beam (1) are fixed to the plate (10) through a connection mechanism (16), to which both are attached through fastening elements, allowing the spring (13) to function. This interconnection presents small gaps between the various components that make up the lifting beams (1) and allows for truck loading and unloading even if they are not correctly leveled and aligned, adjusting as necessary.

Fastening elements include screws, rivets, nuts, and similar items.

FIG. 9 shows a view from underneath the standard PBR pallet (2) with two pneumatic lifting beams (1) of the loading mechanism passing through the inside (interior) of the pallet, with their wheels (141) retracted, allowing them to pass over the billets (21) of the pallet (2).

FIG. 10 shows a view from underneath the standard PBR pallet (2) with the two pneumatic lifting beams (1) in the expanded position, with the wheels (1) extending outside the pallet (2) and lifting the pallet (2) approximately 30 mm off the ground.

FIGS. 11 and 12 show the truck loading and unloading equipment installed in a warehouse with a properly aligned truck trailer (8), with pallets (2) being loaded by a forklift, forming a complete load that will be loaded into the trailer (8), passing over the tipping ramps (9) that connect the dock to the trailer (8) and allow the load and lifting beams (1) to pass over them and enter the trailer (8), leaving the pallets (2) and exiting the trailer (8) with the lifting beams (1) empty. This entry and exit movement is completed in less than five minutes. As shown in FIG. 11, the correct alignment of the trailer door (81) with the lifting beam system (1) compensates for any lateral or frontal misalignment due to the fact that the lifting beams (1) are not a rigid assembly but rather formed by several interconnected sets, creating flexible equipment that simplifies its use. It is much easier and simpler to align a trailer door (81) or truck than to align the entire vehicle and also support or adjust its suspension during the loading and unloading processes.

To align the truck trailer (8) with the dock and the lifting beam system (1), any system that allows the trailer (8) to move horizontally and vertically, ensuring the correct positioning of the trailer door (81) with the dock opening, can be used. For example, trucks can perform a pre-alignment at the dock by entering a tunnel created with two pipes fixed to the floor. A hydraulic system with a stop aligns the trailer (8) up or down, while a second hydraulic system moves plates over the trailer axles (8) to make the lateral alignment of the vehicle. The important thing is that in this system, only the door needs to be aligned with the equipment, not the entire vehicle, thanks to the flexibility of the lifting beams.

1. Equipment for loading and unloading trucks composed of lifting beams made of a rigid plate, which is placed over a pneumatic hose pressed against its lower part with a platform, rails, a carriage, and horizontal beams, the equipment being composed of:
lifting beams moved on rails by a carriage with arms operated by the motor, wherein said beams are composed of a platform connected to a leaf spring; and connected to the platform through fastening elements, wherein the beam contains two movable arms with wheels;
rails formed by bars where the lifting beams are fitted and moved;
a carriage with arms fixed to the lifting beams and with a motor that rotates a shaft connected to gears that move chains where the carriage is fixed;
ducts that surround the chains and fix the shaft to the gears at their ends; and
horizontal beams that fix the rails and the ducts to each other.

2. The equipment for loading and unloading trucks according to claim 1, containing a motor, fixed to the duct, responsible for moving the chain conveyors.

3. The equipment for loading and unloading trucks according to claim 1, characterized by containing one or more lifting beams composed of arms that pivot around shafts fixed to the plate, with wheels fixed to the end of the arm and attached to supports, wherein the platform is supported on shafts that pass through the sides of the plate, fixed by nuts.

4. The equipment for loading and unloading trucks according to claim 1, containing a second line of chain conveyors and roller mechanisms, wherein the motor connected to the chains through a shaft moves the chains inside the ducts, acting as rails for moving pallets, guiding them to the roller mechanism.

5. A method for lifting loads implemented by the lifting beam of claim 1, characterized by the lifting beam keeping the wheels retracted and the pneumatic hose compressed against a platform by springs; and by introducing air, the hose moves the platform and the springs downward, pushing the wheels out of the structure plate, thus lifting the products placed on it through the pressure applied to the wheel arm by the support, made of sliding material
